(19) United States
(12) Patent Application Publication
(10) Pub. No.: US 2022/0169292 A1
(43) Pub. Date: Jun. 2, 2022

(54) DAMPER FOR A RAIL VEHICLE, MONITORING SYSTEM FOR A DAMPER AND METHOD FOR MONITORING A DAMPER

(71) Applicant: DELLNER COUPLERS AB, FALUN (SE)

(72) Inventors: Magnus LIZELL, LIDINGÖ (SE); Per STRANDBERG, FALUN (SE); Anders WESTMAN, FALUN (SE); Thilo KOCH, HAMBURG (DE)

(21) Appl. No.: 17/617,125

(22) PCT Filed: Jun. 1, 2020
(86) PCT No.: PCT/SE2020/050553

§ 371 Date: Dec. 7, 2021

(30) Foreign Application Priority Data
Jun. 10, 2019 (SE) 1950691-4

(51) Int. Cl. B61G 11/12; F16F 9/06; F16F 9/32; F16F 9/084

(52) U.S. Cl. CPC B61G 11/12; F16F 9/063; F16F 2230/24; F16F 9/067; F16F 9/084; F16F 9/3292

(57) ABSTRACT

The present invention relates to a damper for a rail vehicle, the damper comprising —a cylindrical housing (1) wherein a hollow piston (2) is received axially movable, —a working chamber (5) of variable volume in the housing, —a overflow chamber (4) of variable volume in the piston, the hydraulic overflow chamber (5) being connected to the hydraulic working chamber (5) via a throttle (8) that is in a flow passage between the working chamber (5) and the overflow chamber (4), —a spring chamber (3) of variable volume in the piston, the spring chamber (3) being configured to hold a gas volume for acting as a spring, and the spring chamber being separated from the hydraulic overflow chamber (4) by a separator piston (6) that is axially movable, and the damper further comprising a pressure detector (7) that is configured to detect a pressure in at least one of the spring chamber (3), the working chamber (5) and the overflow chamber (4). The invention also relates to a monitoring system and to a method for monitoring a pressure in a damper.

### TECHNICAL FIELD

The present invention relates to a damper for a rail vehicle, the damper comprising a hydraulic working chamber and a hydraulic overflow chamber that are in fluid communication with each other via a throttle. The invention also relates to a monitoring system for monitoring such a damper and to a method for monitoring such a damper.

### BACKGROUND

Hydraulic dampers, in the field also referred to as buffers, are commonly installed in central buffer couplings adapted for connection of rail vehicles. In the central buffer coupling a damper can be effective for absorbing shock loads in both compression and extension of the damper, in this way reducing jerking and smoothening the ride for passengers.

The general function and structure of the subject hydraulic dampers include a hollow piston which is received axially movable in a cylindrical housing. A volume of hydraulic fluid is contained in a working chamber in the housing. The working chamber communicates with an overflow chamber in the piston via a restriction. In compression of the damper, such as in the case of a buff load higher than moderate which pushes the piston further into the housing, hydraulic fluid is forced via the restriction into the overflow chamber as the volume of the working chamber is reduced. A partitioning element which slides freely in the hollow piston is displaced by the inrushing fluid, this way increasing the volume of the overflow chamber. The partition wall is displaced against the force of a compressible spring which is loaded while absorbing most or all of the energy that caused compression of the damper. This spring is usually a gas volume which under moderate load absorbs the energy generated in compression of the damper. In extension of the damper the spring releases its accommodated energy to return hydraulic fluid in the overflow chamber back to the working chamber. The reverse flow is typically routed other way bypassing the restriction, this way permitting a non-restricted return of the piston to its unloaded position. With the purpose of avoiding a heavy recoil as the piston is returned in extension motion, an additional chamber can be arranged to receive a smaller volume of hydraulic fluid during compression while returning the same volume via a restricted passage during extension of the damper, this way balancing the expansion of the gas spring and of the damper.

One problem commonly associated with dampers or buffers is that their performance is highly dependent on being able to retain the hydraulic fluid and the gas volume of the spring in order to absorb energy and then return to their original state so that they can be subjected to compressive forces again. If the performance of the damper decreases due to a low internal pressure, the stroke is reduced and therefore also the energy absorption capacity. The compressive force is then at least partly absorbed by other components such as non-regenerative elements of the train crash energy management system, so that the overall capacity to absorb crash energy is reduced. The result is that the ability of the systems provided for absorbing energy in the event of a crash is decreased and the structure can be damaged at lower speeds than intended.

At present, faulty dampers are repaired or replaced during normal maintenance that takes place at long but regular intervals. For logistic and economic reasons it is not possible to schedule maintenance at shorter intervals and it is also difficult to predict when performance loss at the damper would occur since many factors contribute to cause wear and damage.

There is therefore a need for an improved damper that solves the problems associated with decreased performance.

### SUMMARY

The object of the present invention is to eliminate or at least to minimize the problems discussed above. This is achieved by a damper, a monitoring system and a method for monitoring a damper according to the appended independent claims.

The damper according to the present invention comprises
a cylindrical housing wherein a hollow piston is received axially movable,
a working chamber of variable volume in the housing,
a overflow chamber of variable volume in the piston, the hydraulic overflow chamber being connected to the hydraulic working chamber via a throttle that is in a flow passage between the working chamber and the overflow chamber,
a spring chamber of variable volume in the piston, the spring chamber being configured to hold a gas volume for acting as a spring, and the spring chamber being separated from the hydraulic overflow chamber by a separator piston that is axially movable,
and the damper further comprising a pressure detector that is configured to detect a pressure in at least one of the spring chamber, the working chamber and the overflow chamber.

By detecting the pressure inside the damper, it is possible to determine if the performance of the damper has decreased so that the damper needs to be repaired or replaced. Thereby, an increased stability and reliability is achieved and damage to non-regenerative components of the crash energy management system is avoided.

Suitably, the pressure detector comprises at least one pressure sensor that is configured to contact an inside of the spring chamber, working chamber and/or overflow chamber, the pressure sensor preferably being arranged in a wall of the cylindrical housing or the hollow piston. Thereby, the pressure inside the chamber can be detected while the damper is in operation and the pressure sensor forms part of the damper itself.

The pressure detector may advantageously be configured to detect the pressure in the spring chamber. Thereby, the pressure detector is readily available from the outside of the damper for displaying the detected pressure or the state of the pressure sensor or switch.

Suitably, the at least one pressure sensor may be a pressure switch that is configured to detect the pressure and to be in a first state if the detected pressure is below a threshold and to be in a second state if the detected pressure is above said threshold. Thereby, a very stable and robust pressure switch can be used that is able to function over a long lifetime without being damaged or broken while the damper is in operation.

The pressure detector may comprise at least two pressure switches, and each of the pressure switches may be configured to switch between the first and second state at a threshold, wherein preferably each of the switches has a threshold that is different from the threshold of at least one of the other pressure switches. Thereby, a more detailed information of the detected pressure can be given while at the same time using the stable and robust switches.

Suitably, the pressure detector may be configured to detect the pressure and to, by means of processing circuitry that is comprised in the pressure detector or that is available to the pressure detector, compare the detected pressure with at least one threshold or pressure interval, the pressure detector may further be configured to generate a signal that corresponds to the detected pressure. The processing circuitry may be comprised in the pressure detector or in a remote control unit, and the pressure detector or remote control unit may be configured to generate an information signal comprising information of whether the detected pressure is above or below one of the at least one thresholds or in one of the at least one pressure intervals.

The invention also comprises a monitoring system for monitoring a pressure in at least one damper, the system comprising at least one damper according to the invention and also comprising a control unit configured to communicate with the pressure detector of the damper.

Furthermore, the invention also comprises a method for monitoring a pressure in a damper, the method comprising
providing at least one damper according to the invention,
detecting a pressure in at least one spring chamber, overflow chamber or working chamber of the damper,
generating at least one signal corresponding to the detected pressure, and
transmitting said signal to processing circuitry for monitoring the pressure in the chamber of the damper, the processing circuitry preferably being provided in the pressure detector of the damper or in a control unit.

The method may comprise comparing the detected pressure with at least one predetermined threshold and generating an alarm signal if the detected pressure is below the predetermined threshold. Furthermore, the method suitably comprises comparing the detected pressure with at least one but preferably a plurality of predetermined pressure intervals and generating an information signal comprising information of whether the detected pressure falls within a predetermined pressure interval.

Suitably, the method also comprises providing a plurality of dampers according to the invention, each being configured to detect a pressure in at least one spring chamber, overflow chamber or working chamber of the damper and transmitting signals corresponding to the detected pressure to the remote control unit.

The present invention also relates to a data processing apparatus, a computer program product and a computer-readable storage medium as described further below.

Many additional benefits and advantages of the present invention will be readily understood by the skilled person in view of the detailed description below.

### DRAWINGS

The invention will now be described in more detail with reference to the appended drawings, wherein

FIG. 1 discloses a schematic view of a damper according to a preferred embodiment of the present invention;

FIG. 2 discloses schematically a monitoring system for monitoring the damper of FIG. 1;

FIG. 3 discloses a method for monitoring the damper of FIG. 1;

FIG. 4 discloses the comparison of a signal with predetermined thresholds or intervals; and

FIG. 5 discloses gas pressure in a damper in relation to stroke length.

### DETAILED DESCRIPTION

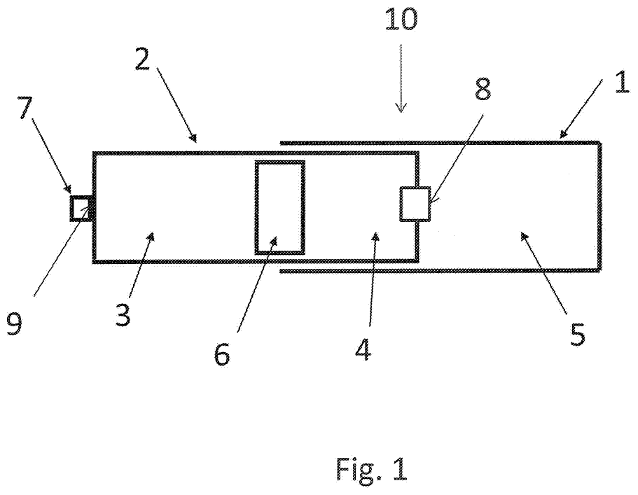

With reference to FIG. 1 the main structural components of a damper 10 according to a preferred embodiment of the present invention include a hollow piston 2 received to move axially in compression and extension directions in a cylinder housing 1. A hydraulic working chamber 5 in the housing 1, containing a volume of hydraulic fluid, is in fluid flow communication with an external hydraulic overflow chamber 4 in the hollow piston 2 via a throttle 8 that may suitably be in the form of a flow restriction and a non-return valve. The throttle is thus set to open in response to an increased predetermined pressure being generated in the hydraulic fluid volume in the working chamber, as the result of the piston and housing being compressed by external force. A gas volume in a spring chamber 3 is then compressed and loaded as hydraulic fluid is shifted from the working chamber to the overflow chamber. When the load on the piston ceases the gas expands to shift the fluid in the overflow chamber back to the working chamber via the throttle that can comprise a non-return valve, in a recoil following upon a compressive shock load. The spring chamber 3 is connected to the overflow chamber 4 but is separated from it by a separator piston 6 that is axially movable. As the fluid is returned to the working chamber 5 the separator piston 6 is able to move axially towards the overflow chamber 4 so that the pressure in the gas of the spring chamber 3 is decreased.

Also provided in the damper 10 is a pressure detector 7 that is arranged in the housing 1 or the piston 2 to detect a pressure in at least one of the working chamber 5, overflow chamber 4 or spring chamber 3 so that the pressure of either the fluid in the working chamber 5 and overflow chamber 4 or the gas in the spring chamber 3 is detected. In FIG. 1, the pressure detector 7 is arranged in connection with the spring chamber 3 and this has the benefit that the pressure detector 7 is easily accessible from outside the damper 10. In other embodiments the pressure detector could instead be arranged in connection with the working chamber 5 or the overflow chamber 4.

In the preferred embodiment, the pressure detector 7 comprises a pressure sensor 9 that is arranged in the wall of the damper 10 so that the sensor is in contact with an inside of the spring chamber 3, overflow chamber 4 or working chamber 5 and so that the sensor can detect the pressure by directly contacting the gas or fluid in that chamber 3, 4, 5.

In one embodiment, the pressure sensor 9 is a mechanical switch that is set to be in a first state when a detected pressure is below a threshold value and to be in a second state when the detected pressure is above the threshold. This is a very simple and robust embodiment with a long lifetime and that is not easily damaged or broken even during operation of the damper 10 in a rail vehicle for long periods of time. The pressure switch is preferably arranged to be visible from outside the damper 10 so that the state of the switch can be seen by an operator that is tasked with determining whether the performance of the damper is still acceptable. By looking at the switch, the state of the damper 10 can be immediately decided since the switch being in the first state will signify the pressure has dropped below the threshold so that the damper does not operate as desired, whereas the switch being in the second state will signify that the pressure is still at a sufficiently high level for the damper to be able to continue operation. A desirable pressure in the damper may be 30 bar, and the threshold can then suitably be selected to 20 bar.

In another embodiment, the pressure sensor 9 comprises a plurality of mechanical switches. This can either serve the purpose that two switches arranged side by side with the same threshold value will provide a redundancy that allows for the malfunction of one of the switches without hindering evaluating the performance of the damper 10. In such embodiments, the situation where the two switches show different states would signify that one of them is broken and the damper 10 could be repaired or replaced to ensure that operation of the rail vehicle can continue.

The other purpose of having a plurality of switches is that they can be arranged to have different threshold values, so that they are able to show in a more detailed manner what the pressure inside the damper 10 actually is. When a first switch is set to have a first threshold of a first value and a second switch is set to have a second threshold of a second value that is lower than the first value, it can be decided by looking at the switches whether the pressure inside the damper 10 is above the first value since both switches will be in the second state. When the pressure inside the damper is below the first value but above the second value, the first switch will be in the first state but the second switch will still be in the second state. And when the pressure is below the second value, both switches will be in the first state. For a damper that should have a pressure of 30 bars, the first value could be 20 bars, signifying that the damper could continue operation until maintenance can be scheduled, and the second value could be 10 bars, signifying that the damper must be replaced immediately. A larger number of switches are of course also possible and would give an even more detailed information of the pressure in the damper 10.

The state of the switches can be detected by the switches being visible to an observer, as mentioned above. Alternatively, the state of the switches can be detected by applying a measuring tool that acts to create a closed circuit that includes the switch or switches. The first state can correspond to a current being able to pass through the switch and the second state can correspond to the circuit being broken at the switch so that current cannot pass, or vice versa. By applying the tool and detecting an electrical property such as a current, a voltage, a resistance or an impedance, it can be determined in which state the switch or switches is/are. Suitably, the switches can be connected to each other in series or in parallel or in any configuration of serial and parallel connection, or can alternatively each form a separate circuit when the tool is applied. When the pressure detector 7 is configured to detect the pressure inside the overflow chamber 4 or working chamber 5, the tool facilitates detecting the state of the switches since they may not be readily available from the outside of the damper 10.

In another embodiment, the pressure detector comprises a sensor that is configured to detect the pressure and to generate a signal that corresponds to the detected pressure. The sensor may monitor the pressure continuously or may alternatively detect the pressure at given intervals such as once per minute, once per hour or once per day. The pressure detector may suitably be configured to transmit the generated signal to a remote control unit 100.

In this embodiment, the pressure detector 7 comprises the sensor and may also comprise a transmitter and optionally a receiver for communicating with the control unit 100. Suitably, the pressure detector 7 also comprises a memory unit for storing the detected pressure and may further comprise processing circuitry able to compare the detected pressure with a predetermined threshold value or with at least one but optionally a plurality of pressure intervals. The pressure detector 7 can then receive a signal from the pressure sensor 9 and compare it with the predetermined intervals or thresholds to decide how the pressure in the chamber 3, 4, 5 relates to the thresholds or intervals. Based on this, the pressure detector 7 can generate and transmit an information signal to the control unit 100. If the pressure is lower than acceptable, the signal could signify that maintenance should be scheduled but that there is at present no risk of malfunction of the damper. If the pressure is even lower, the signal could instead signify that maintenance must take place within a given time or as soon as possible. For a pressure below a level that corresponds to the damper 10 being unable to function to absorb energy even on a low but acceptable level, the signal could instead signify that the damper must be replaced or repaired immediately to avoid damage to other components on the rail vehicle or to persons or goods travelling inside the rail vehicle. The pressure detector 7 could also be a largely passive component that detects the pressure only when given instruction by the control unit 100.

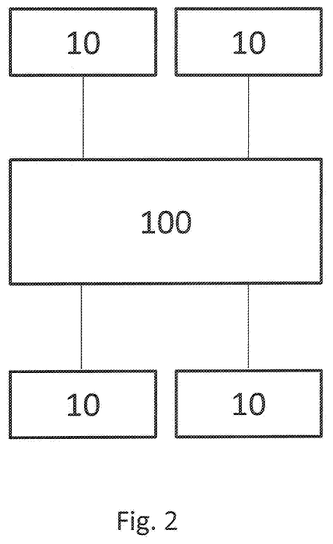

Optionally, the control unit 100 may comprise the memory unit and the processing circuitry so that the pressure detector 7 only generates and transmits the signals that correspond to the pressure in the chamber 3, 4, 5. In a monitoring system according to the present invention, the control unit 100 is operatively connected to at least one damper 10 but preferably to a plurality of dampers 10 that each transmit signals to the control unit 100 and optionally also receive signals from the control unit 100 (see FIG. 2).

Optionally, the memory unit can be separate from both the pressure detector 7 and the control unit 100 and may be available to the pressure detector 7 and/or the control unit 100 via a wireless connection. The memory unit can in such embodiments be accessible through internet or in the form of a cloud memory unit.

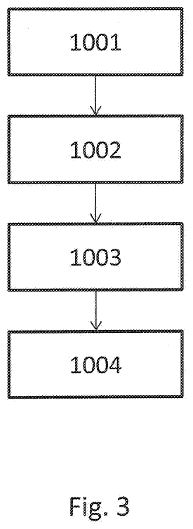

FIG. 3 discloses a method for monitoring a pressure in a damper according to the present invention. The method comprises providing 1001 at least one damper 7 according to the present invention and detecting 1002 a pressure in at least one chamber 3, 4, 5 of the damper, followed by generating 1003 at least one signal corresponding to the detected pressure, and transmitting 1004 said signal to processing circuitry for monitoring the pressure in the chamber 3, 4, 5 of the damper. The processing circuitry may be provided in the control unit 100 or may alternatively be provided in the pressure detector 7 itself.

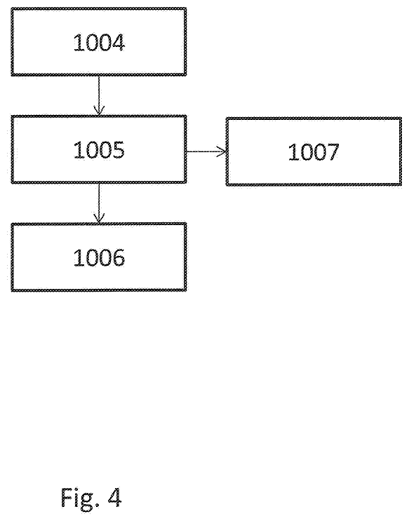

In FIG. 4, further aspects of the inventive method are disclosed. After the signal is transmitted 1004 to the processing circuitry of the control unit 1000 or of the pressure detector 7, the signal is compared 1005 to at least one threshold value or pressure interval to determine how the detected pressure relates to them. If the detected pressure is found to be within an interval or below a threshold that signifies that operation of the damper 10 has decreased so that an action must be taken, an information signal is generated 1006. The information signal may contain different information depending on in which pressure interval the detected pressure is, as described above. If the detected pressure is found to be in an interval or above a threshold that means that no action should be taken, a signal containing such information may be generated 1007 or alternatively no signal at all is generated. The generated information signal may be transmitted from the unit comprising the processing circuitry, such as the control unit 1000 or the pressure detector 7, or alternatively the information signals may be stored in the memory unit, or both. Thus, in one embodiment of the inventive method, the detected pressure may be compared with at least one predetermined threshold and generating an alarm signal if the detected pressure is below the predetermined threshold. The information signal is in this instance an alarm signal.

In another embodiment the method may comprise comparing the detected pressure with at least one but preferably a plurality of predetermined pressure intervals and generating an information signal corresponding to whether the detected pressure falls within a predetermined pressure interval.

A plurality of dampers 10 may be included to provide signals that are compared with thresholds or intervals as described above, and they may communicate with the control unit 1000 or may alternatively each comprise the processing circuitry.

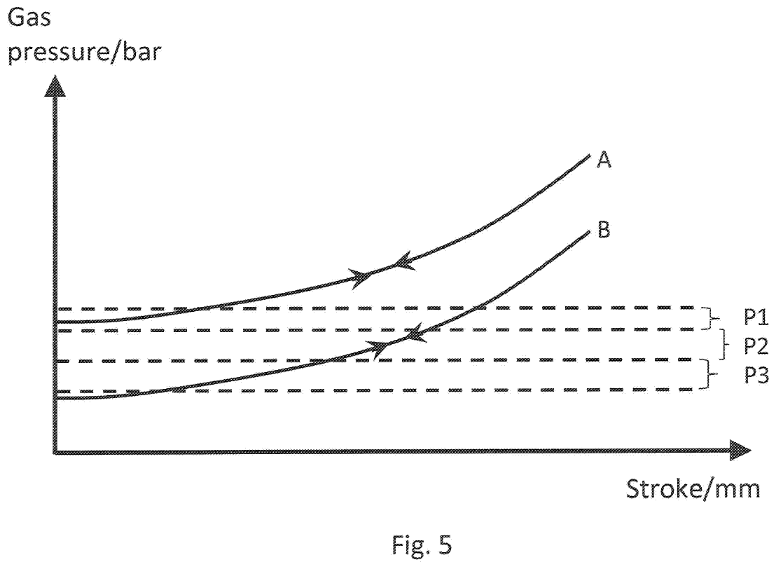

FIG. 5 discloses the pressure in the damper 10 according to the invention in relation to stroke length of the damper 10. A first curve A discloses a fully functioning damper, whereas a second curve B discloses a damper with a lower pressure than acceptable. Pressure intervals P1, P2 and P3 are also disclosed, in which a first pressure interval P1 signifies that the damper 10 operates slightly less efficiently than desired but that maintenance is not necessary. A second pressure interval P2 signifies that the pressure is low and that maintenance should be scheduled as soon as it is suitable, whereas a third pressure interval P3 signifies that the pressure is too low and that the damper should immediately be replaced or repaired.

Although embodiments of the invention described above with reference to the figures comprise a remote control unit 100, and processes performed in at least one processing circuitry, the invention also extends to computer programs, particularly computer programs on or in a carrier, adapted for putting the invention into practice. The programs may be in the form of source code, object code, a code intermediate source and object code such as in partially compiled form, comprise software or firmware, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

In one or more embodiments, there may be provided a computer program loadable into a memory communicatively connected or coupled to at least one data processor, e.g. the remote control unit 100, comprising software or hardware for executing the method according any of the embodiments herein when the program is run on the at least one data processor.

In one or more further embodiment, there may be provided a processor-readable medium, having a program recorded thereon, where the program is to make at least one data processor, e.g. the remote control unit 100, execute the method according to of any of the embodiments herein when the program is loaded into the at least one data processor.

It is to be noted that features from the various embodiments described herein may freely be combined, unless it is explicitly stated that such a combination would be unsuitable.

1. Damper for a rail vehicle, the damper comprising
a cylindrical housing (1) wherein a hollow piston (2) is received axially movable,
a working chamber (5) of variable volume in the housing,
a overflow chamber (4) of variable volume in the piston, the hydraulic overflow chamber (5) being connected to the hydraulic working chamber (5) via a throttle (8) in a flow passage between the working chamber (5) and the overflow chamber (4),
a spring chamber (3) of variable volume in the piston, the spring chamber (3) being configured to hold a gas volume for acting as a spring, and the spring chamber being separated from the hydraulic overflow chamber (4) by a separator piston (6) axially movable,
and the damper further comprising a pressure detector (7) configured to detect a pressure in at least one of the spring chamber (3), the working chamber (5) and the overflow chamber (4).

2. Damper according to claim 1, wherein the pressure detector (7) comprises at least one pressure sensor (9) configured to contact an inside of the spring chamber (3), working chamber (5) and/or overflow chamber (4), the pressure sensor (9) preferably being arranged in a wall of the cylindrical housing (1) or the hollow piston (2).

3. Damper according to claim 1, wherein the pressure detector (7) is configured to detect the pressure in the spring chamber (3).

4. Damper according to claim 1, wherein the at least one pressure sensor (9) is a pressure switch configured to detect the pressure and to be in a first state if the detected pressure is below a threshold and a second state if the detected pressure is above said threshold.

5. Damper according to claim 4, wherein the pressure detector (7) comprises at least two pressure switches, each of the pressure switches is configured to switch between the first and second state at a threshold, and preferably each of the switches has a threshold that is different from the threshold of at least one of the other pressure switches.

6. Damper according to claim 1, wherein the pressure detector (7) is configured to detect the pressure and, by processing circuitry comprised in the pressure detector (7) or available to the pressure detector (7), compare the detected pressure with at least one threshold or pressure interval, the pressure detector (7) further being configured to generate a signal that corresponds to the detected pressure.

7. Damper according to claim 6, wherein the processing circuitry is comprised in the pressure detector (7) or in a remote control unit (100), and the pressure detector (7) or remote control unit (100) is configured to generate an information signal comprising information of whether the detected pressure is above or below one of the at least one thresholds or in one of the at least one pressure intervals.

8. Monitoring system for monitoring a pressure in at least one damper, the system comprising at least one damper (10) according to claim 6 and also comprising a control unit (100) configured to communicate with the pressure detector of the damper.

9. Method for monitoring a pressure in a damper, the method comprising
providing (1001) at least one damper according to claim 1,
detecting (1002) a pressure in at least one spring chamber (3), overflow chamber (4) or working chamber (5) of the damper,
generating (1003) at least one signal corresponding to the detected pressure, and
transmitting (1004) said signal to processing circuitry for monitoring the pressure in the spring chamber (3), working chamber (5) and/or overflow chamber (4), of the damper (10), the processing circuitry preferably being provided in the pressure detector (7) of the damper (10) or in a control unit (100).

10. Method according to claim 8, further comprising
comparing (1005) the detected pressure with at least one predetermined threshold and generating (1006) an alarm signal if the detected pressure is below the predetermined threshold.

11. Method according to claim 8, further comprising
comparing the detected pressure with at least one but preferably a plurality of predetermined pressure intervals and generating (1006) an information signal comprising information of whether the detected pressure falls within a predetermined pressure interval.

12. Method according to claim 8, further comprising
providing a plurality of said dampers (10), each being configured to detect a pressure in at least one spring chamber (3), overflow chamber (4) or working chamber (5) of the damper (10) and transmitting signals corresponding to the detected pressure to the remote control unit (100).

13. A data processing apparatus comprising means for carrying out the method of claim 9.

14. A computer program product comprising instructions which, when the program is executed by a computer, cause the computer to carry out the method of claim 9.

15. A computer-readable storage medium comprising instructions which, when executed by a computer, cause the computer to carry out the method of claim 9.

16. Damper according to claim 2, wherein the pressure detector (7) is configured to detect the pressure in the spring chamber (3).

17. Damper according to claim 16, wherein the at least one pressure sensor (9) is a pressure switch configured to detect the pressure and be in a first state if the detected pressure is below a threshold and a second state if the detected pressure is above said threshold.

18. Damper according to claim 3. wherein the at least one pressure sensor (9) is a pressure switch configured to detect the pressure and be in a first state if the detected pressure is below a threshold and a second state if the detected pressure is above said threshold.

19. Damper according to claim 2. wherein the at least one pressure sensor (9) is a pressure switch configured to detect the pressure and be in a first state if the detected pressure is below a threshold and a second state if the detected pressure is above said threshold.

20. Damper according to claim 17, wherein the pressure detector (7) comprises at least two pressure switches, each of the pressure switches is configured to switch between the first and second state at a threshold, and preferably each of the switches has a threshold that is different from the threshold of at least one of the other pressure switches.
